(19) United States
(12) Patent Application Publication
(10) Pub. No.: US 2009/0136837 A1
(43) Pub. Date: May 28, 2009

(54) BATTERY PACK AND METHOD FOR MANUFACTURING THE SAME

(76) Inventors: Hirotada KOMOTO, Osaka (JP); Tatsuya Inakami, Osaka (JP); Munetoshi Kagaya, Osaka (JP); Kazutaka Nishiwaki, Osaka (JP)

Correspondence Address: BIRCH STEWART KOLASCH & BIRCH, PO BOX 747, FALLS CHURCH, VA, 22040-0747, US

(21) Appl. No.: 12/277,669

(22) Filed: Nov. 25, 2008

(30) Foreign Application Priority Data
Nov. 27, 2007 (JP) 2007-306321
Nov. 27, 2007 (JP) 2007-306322

(51) Int. Cl. H01M 6/42; B29C 45/14

(52) U.S. Cl. 429/149; 264/261

(57) ABSTRACT

A method for manufacturing a battery pack is provided in which a cell 2 that includes a contact pad 9 attached thereto is placed on a die 24, and a cover that is integrated with the cell 2 and the contact pad 9 is molded. The contact pad 9 includes a body that includes an opening formed therein, and an external connection terminal disposed at the position of the opening. The cover is molded by bringing the surface of the body into contact with a die 26 and injecting a resin into a space surrounded by dies 24, 25, and 26 and the cell 2. The contact is a flat surface contact without fitting.

Accordingly, resin leakage can be prevented with a simple structure in an integrally-molded type battery pack, and thus stable molding can be performed.

### BACKGROUND OF THE INVENTION

1. Field of the Invention

The present invention relates to a battery pack in which a cover that is integrated with a cell and a contact pad is formed by molding, and a method for manufacturing the same.

2. Description of Related Art

For batteries used in cell phones, mobile devices, etc., battery packs that include a protective circuit for preventing excessive charging, excessive current, excessive discharging, etc. are used, rather than using cells alone. For example, a battery pack is known in which a resin cover that houses various attached components including a protective circuit is fixed by mechanical engagement or screwing.

Another battery pack is known in which a protective circuit is covered by resin molding and this covering member is integrally molded to a cell (see JP 2000-315483A). With such an integrally-molded type battery pack, attached components including a protective circuit can be firmly attached to a cell while suppressing the number of components.

However, in the case of an integrally-molded type battery pack as mentioned above, when an external connection terminal is included as an attached component of the cell, it is necessary to prevent the resin from leaking to the position of the terminal when integral molding is performed.

In order to secure positional accuracy of the contact pad, the contact pad needs to be attached at the proper position when integral molding is performed. Particularly when a configuration is adopted in which a die and a contact pad are fitted to prevent resin leakage during molding, the positional accuracy of the contact pad is important from the viewpoint of preventing molding defects.

Furthermore, in recent years, a battery pack in which an external connection terminal is configured to have a two-surface terminal structure also has been proposed, but in such a battery pack that employs the two-surface terminal structure having a complicated shape, the structure for preventing resin leakage during molding also becomes complicated, and stable molding is expected to become difficult.

On the other hand, no reference has been found that proposes a molding technique for achieving stable molding for battery packs that employ the two-surface terminal structure.

The present invention has been made to solve the problems encountered in conventional technology described above, and it is an object of the present invention to provide an integrally-molded type battery pack, wherein stable molding can be performed by preventing resin leakage with a simple structure, and molding can be performed in a state in which the positional accuracy of a contact pad is secured, and a method for manufacturing such a battery pack.

### SUMMARY OF THE INVENTION

In order to achieve the above object, a first method for manufacturing a battery pack according to the present invention is a method for manufacturing a battery pack by placing a cell that includes a contact pad attached thereto in a die and molding a cover that is integrated with the cell and the contact pad, wherein the contact pad comprises a body that includes an opening formed therein, and an external connection terminal disposed at the position of the opening, the cover is molded by bringing the surface of the body into contact with a die and injecting a resin into a space surrounded by the die and the cell, and the contact is a flat surface contact without fitting.

A second method for manufacturing a battery pack according to the present invention is a method for manufacturing a battery pack by housing a cell that includes a contact pad attached thereto in a space surrounded by a plurality of dies, and molding a cover that is integrated with the cell and the contact pad, wherein the contact pad comprises a body that includes an opening formed therein, and an external connection terminal disposed at the position of the opening, the plurality of dies include a die having projections that fit to both ends of the contact pad, the cell that includes a contact pad attached thereto is placed on the die having projections, and after both ends of the contact pad are fitted to the projections, the plurality of dies are brought into a closed state, and a resin is injected into a space surrounded by the plurality of dies and the cell to mold the cover.

A first battery pack according to the present invention is a battery pack in which a cover is molded to a cell that includes a contact pad attached thereto so as to integrate with the cell and the contact pad, wherein the contact pad comprises a body that includes an opening formed therein, and an external connection terminal disposed at the position of the opening, and the surface of the body has a shape that can make a flat surface contact without fitting together with a die for forming the cover.

A second battery pack according to the present invention is a battery pack in which a cover is molded to a cell that includes a contact pad attached thereto so as to integrate with the cell and the contact pad, wherein the contact pad comprises a body that includes an opening formed therein, and an external connection terminal disposed at the position of the opening, a recess is formed in the cover, and the recess is formed contacting each of both ends of the contact pad.

### BRIEF DESCRIPTION OF THE DRAWINGS

FIG. 1 is a perspective exploded view of a battery pack according to an embodiment of the present invention.

FIG. 2 is a perspective view of an assembly according to an embodiment of the present invention before it is placed in a mold.

FIG. 3A is a perspective view of a contact pad according to an embodiment of the present invention.

FIG. 3B is a perspective view of a contact pad according to a comparative example.

FIG. 4A is a cross sectional view of a die used for integral molding according to an embodiment of the present invention, in which the die is open.

FIG. 4B is a cross sectional view of the die used for integral molding according to an embodiment of the present invention, in which the die is closed.

FIG. 5 is a plan view showing a state in which the die according to the embodiment of the present invention is closed.

FIG. 6A is a plan view showing a state before a sliding core is brought into contact with a contact pad, according to the embodiment of the present invention.

FIG. 6B is a plan view showing a state after the sliding core is brought into contact with the contact pad, according to the embodiment of the present invention.

FIG. 7A is a plan view showing a state before a sliding core is brought into contact with a contact pad, according to a comparative example.

FIG. 7B is a plan view showing a state after the sliding core is brought into contact with the contact pad, according to a comparative example.

FIG. 8 is an enlarged view of a relevant part showing a contact state between a contact pad and a die according to an embodiment of the present invention.

FIG. 9A is a plan view of a relevant part of a contact pad positioning structure portion according to an embodiment of the present invention.

FIG. 9B is a perspective view of a relevant part of the contact pad positioning structure portion according to the embodiment of the present invention.

FIG. 10 is a perspective view showing the periphery of a contact pad to which a cover has been molded.

### DETAILED DESCRIPTION OF THE INVENTION

According to the first method for manufacturing a battery pack and the first battery pack of the present invention, even if the position of the contact pad is offset in the width direction of the cell when molding the cover portion that is integrated with the cell and the contact pad, it is possible to prevent the formation of a gap in the contact portion between the die and the contact pad, and the resin from flowing from the contact portion to the terminal portion. Accordingly, molding defects can be prevented, and thus stable molding becomes possible.

According to the second method for manufacturing a battery pack and the second battery pack of the present invention, even if the position of the contact pad is offset in the width direction of the cell when molding the cover portion that is integrated with the cell and the contact pad, with the projections integrated with the die, the position of the contact pad can be corrected to the proper position. Accordingly, the cover can be molded with a simple structure while securing the positional accuracy of the contact pad.

In the first method for manufacturing a battery pack of the present invention, it is preferable that the surface of the body of the contact pad includes a first surface and a second surface that intersects with the first surface, the opening is formed on the first surface side and the second surface side, the terminal is disposed at the position of the opening on the first surface side and the position of the opening on the second surface side, which constitutes a two-surface terminal structure, and the contact is a flat surface contact without fitting in both the first surface and the second surface. With this configuration, even when the contact pad has the two-surface terminal structure, it is possible to prevent molding defects, and thus stable molding becomes possible.

It is also preferable that the opening of the contact pad is divided by ribs, and the ribs are located at a position recessed from the surface of the body toward the terminal side. With this configuration, the contact between the die and the contact pad is more reliably secured, and the resin can be more reliably prevented from flowing into the terminal portion of the contact pad.

In the first battery pack of the present invention, it is preferable that the surface of the body of the contact pad includes a first surface and a second surface that intersects with the first surface, the opening is formed on the first surface side and the second surface side, the terminal is disposed at the position of the opening on the first surface side and the position of the opening on the second surface side, which constitutes a two-surface terminal structure, and the first surface and the second surface have a shape that can make a flat surface contact without fitting together with a die for forming the cover. With this configuration, even when the contact pad has the two-surface terminal structure, molding defects can be prevented, and thus stable molding becomes possible.

It is also preferable that the surface of the body is a flat surface or a flat surface in part of which a recess portion is formed.

It is also preferable that the opening of the contact pad is divided by ribs, and the ribs are located at a position recessed from the surface of the body toward the terminal side. With this configuration, the contact between the die and the contact pad is more reliably secured, and thus it is possible to more reliably prevent the resin from flowing into the terminal portion of the contact pad.

In the second method for manufacturing a battery pack of the present invention, it is preferable that in the closed state of the plurality of dies, the contact between the surface of the body and the plurality of dies is all a flat surface contact without fitting. With this configuration, resin leakage can be prevented with a simple structure, and thus stable molding can be achieved.

It is also preferable that the surface of the body of the contact pad includes a first surface and a second surface that intersects with the first surface, the opening is formed on the first surface side and the second surface side, the terminal is disposed at the position of the opening on the first surface side and the position of the opening on the second surface side, which constitutes a two-surface terminal structure, and the die having projections is a die that corresponds to the first surface or the second surface that serves as a side surface of the cell. With this configuration, even when the contact pad has the two-surface terminal structure, the cover can be molded with a simple structure while securing the positional accuracy of the contact pad.

In the second battery pack according to the present invention, it is preferable that the surface of the body of the contact pad includes a first surface and a second surface that intersects with the first surface, the opening is formed on the first surface side and the second surface side, the terminal is disposed at the position of the opening on the first surface side and the position of the opening on the second surface side, which constitutes a two-surface terminal structure, and the recess is formed at both ends of the first surface or the second surface that serves as a side surface of the cell. This configuration achieves molding of the cover while securing the positional accuracy of the contact pad with a simple structure even when the contact pad has the two-surface terminal structure.

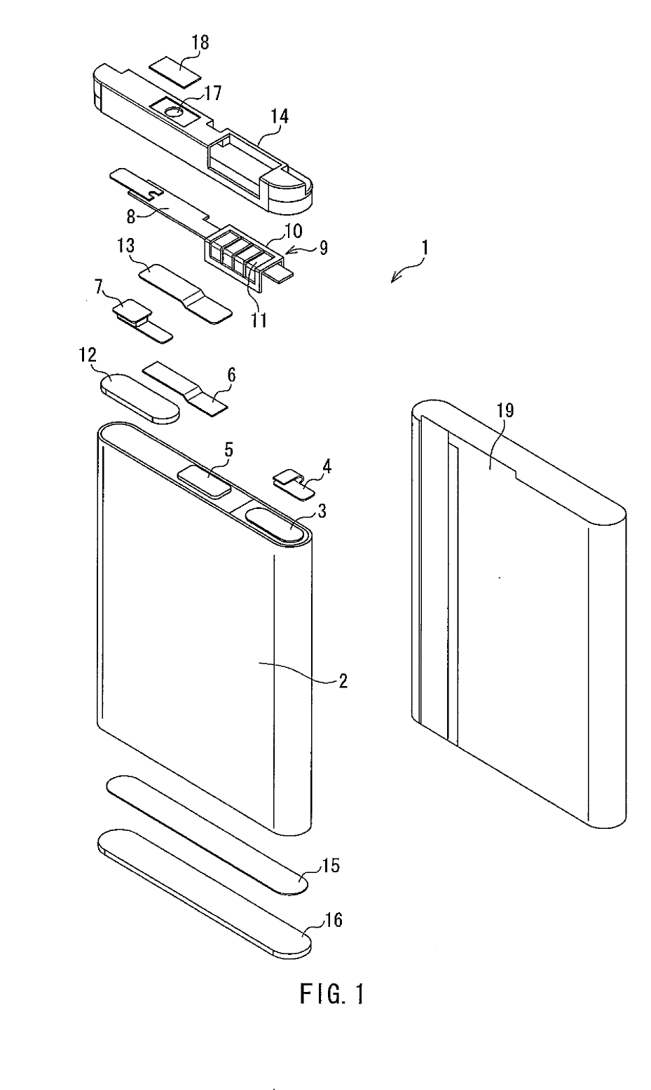

Hereinafter, an embodiment of the present invention will be described with reference to the drawings. FIG. 1 is a perspective exploded view of a battery pack according to an embodiment of the present invention. Referring to FIG. 1, the overall configuration of the battery pack will be described first. FIG. 1 shows a battery pack 1 and various attached components that are attached to the battery pack 1. A cell 2 comprises a power generating element incorporated in a thin rectangular outer can having a small thickness. The cell 2 is, for example, a rectangular lithium ion battery, and is used for a cell phone, mobile device, etc.

A positive electrode tab 4 is welded to a positive electrode terminal 3 and a protective circuit 8. A negative electrode tab 6 is welded to a negative electrode terminal 5. A protective element 7 is welded to the negative electrode tab 6. The protective element 7 is welded to an end of the protective circuit 8. The protective element 7 and the protective circuit 8 are protector for preventing excessive charging, excessive current, excessive discharging, etc.

A contact pad 9 is attached to the protective circuit 8. The contact pad 9 comprises an external connection terminal 11 attached to the opening portion of a resin molded article body 10. When the battery pack 1 is mounted to a subject product, the terminal of the subject product and the terminal 11 of the contact pad 9 come into contact to establish an electrical connection. The body 10 of the contact pad 9 is molded in advance by insert molding so as to integrate with the terminal 11 and the protective circuit 8. An insulator 12 is interposed between the upper portion of the cell 2 and the negative electrode tab 6, and an insulator 13 is interposed between the negative electrode tab 6 and the protective circuit 8.

After various components as described above are attached to the upper portion of the cell 2, a cover 14 is integrally molded to the upper portion of the cell 2. With this integral molding, the cover 14, the cell 2 and the attached components on the upper portion of the cell 2 are integrated. In integral molding, a resin is injected into a portion other than the surface of the contact pad 9 and the terminal 11. Accordingly, the surface of the contact pad 9 and the terminal 11 are exposed through the cover 14 after molding.

After the cover 14 is molded, a can bottom cover 16 is attached to the lower portion of the cell 2 with double-sided tape 15 interposed therebetween, and a label 18 that seals an opening 17 is attached. Finally, a label 19 is wrapped around the outer surface of the cell 2.

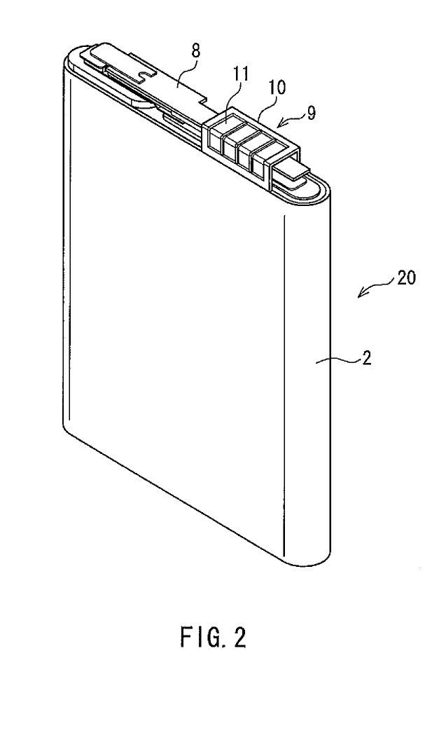

FIG. 2 is a perspective view of an assembly that is placed in a mold. The assembly 20 includes the attached components shown in FIG. 1 on the upper portion of the cell 2 except for the cover 14. The assembly 20 is placed in a mold, and a resin is injected into the mold, thereby integrating the cover 14 with the cell 2.

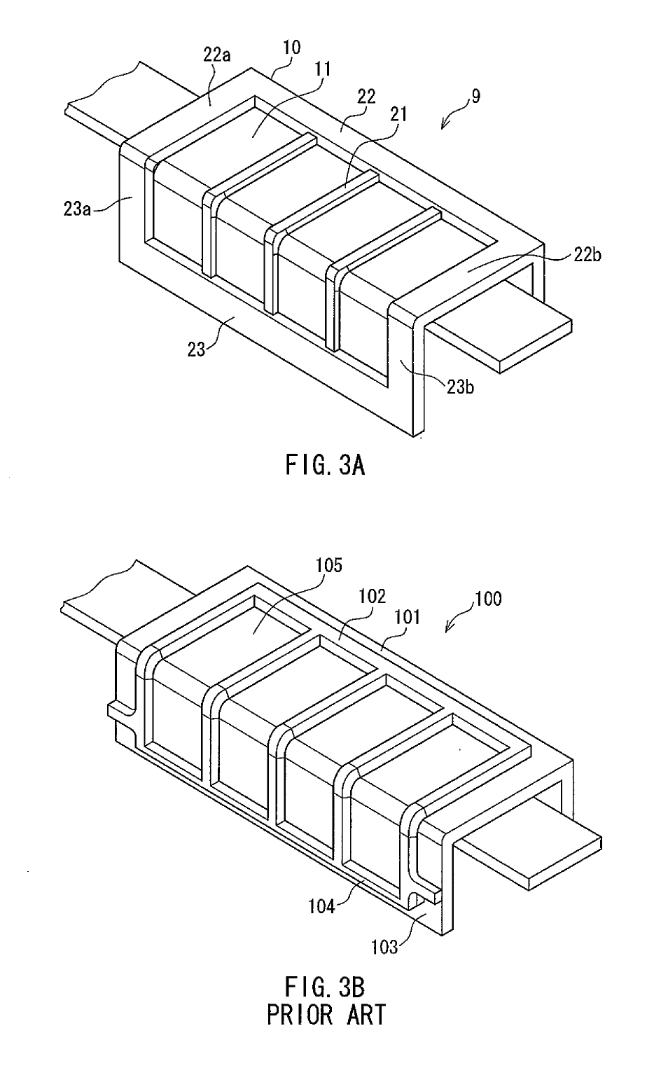

FIGS. 3A and 3B are enlarged perspective views of compact pads. FIG. 3A is a perspective view of a contact pad according to the present embodiment. FIG. 3B is a perspective view of a contact pad according to a comparative example. In FIG. 3A, an opening is formed in the body 10 of the contact pad 9, and the opening is divided by ribs 21. Terminals 11 are disposed so as to correspond to the divided openings.

The surface of the body 10 includes a first surface 22 and a second surface 23 that intersect with each other. The contact pad 9 according to the present embodiment has a two-surface terminal structure in which terminals 11 are disposed at the position of the opening on the first surface 22 side and the position of the opening on the second surface 23 side. The first surface 22 and the second surface 23 are flat, and no protruding portion is formed on these surfaces.

A terminal 105 of a contact pad 100 according to a comparative example shown in FIG. 3B also has a two-surface terminal structure, similar to the contact pad 9 shown in FIG. 3A. However, a protruding portion 102 is formed on a first surface 101, and a protruding portion 104 is formed on a second surface 103. That is, the contact pad 100 according to the comparative example is different from the contact pad 9 shown in FIG. 3A in that a step is formed on the first surface 102 and the second surface 103.

Integral molding according to the present embodiment will be described below by comparing the case of using the contact pad 9 according to the present embodiment with the case of using the contact pad 100 according to the comparative example.

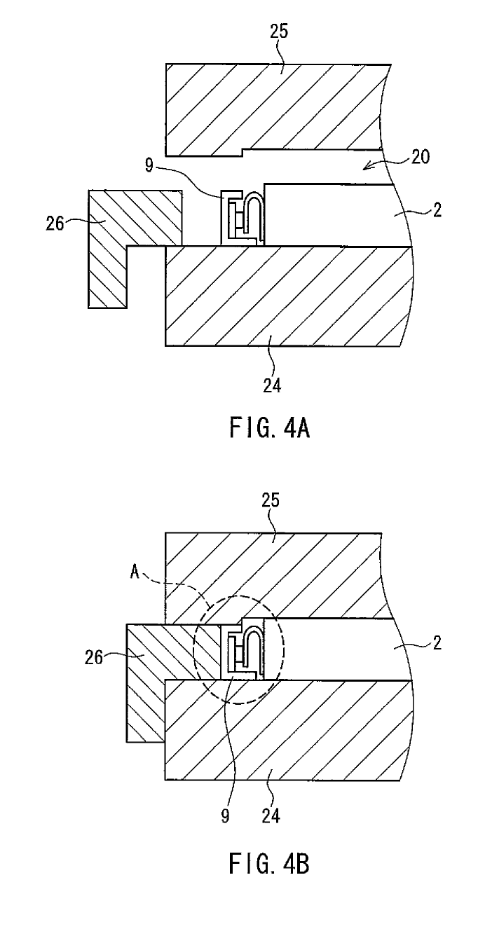

FIGS. 4A and 4B are cross-sectional views of a die for integral molding of the present embodiment. FIG. 4A shows a state in which the die is open, and FIG. 4B shows a state in which the die is closed. The die used for integral molding includes a lower die 24, an upper die 25, and a sliding core 26. As shown in FIG. 4A, the assembly 20 shown in FIG. 2 is placed on the lower die 24. After that, the upper die 25 is moved down, and the sliding core 26 is slid toward the contact pad 9 to close the die. This closed state is shown in FIG. 4B. The cell 2 is sandwiched between the lower die 24 and the upper die 25, and the sliding core 26 is in contact with the contact pad 9.

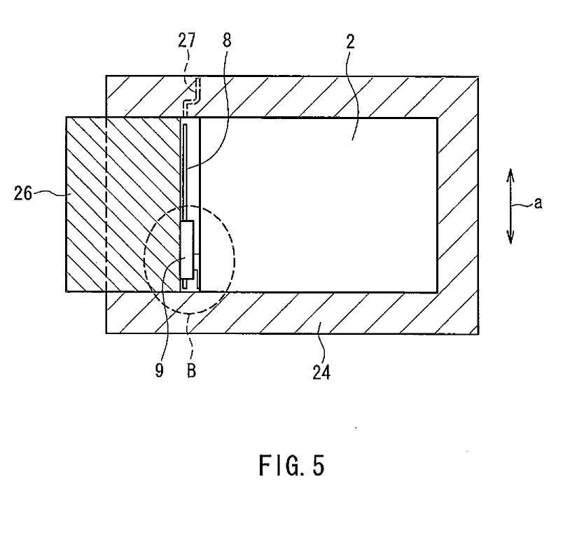

FIG. 5 is a plan view of the state shown in FIG. 4B in which the die is closed. For the sake of simplicity, the upper die 25 is omitted. The cell 2 is housed within the lower die 24, and the position in the width direction (the direction indicated by arrow a) is fixed. A resin is injected into a space (see FIG. 4B) surrounded by the lower die 24, the upper die 25, the sliding core 26 and the cell 2 through a resin injection path 27 shown in FIG. 5, and thus the cover 14 (FIG. 1) is molded integrally with the cell 2.

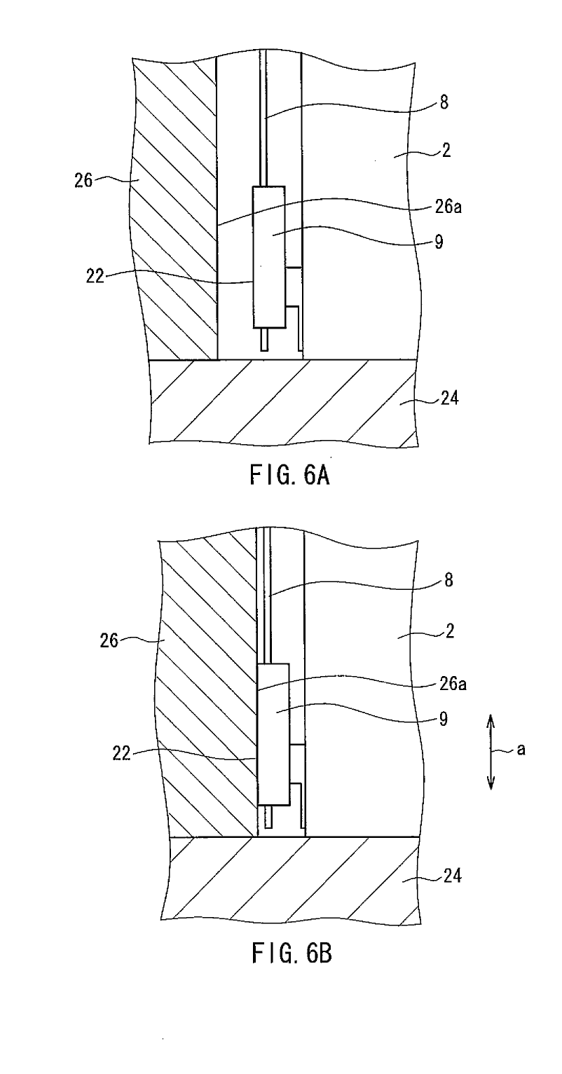

FIGS. 6A and 6B are plan views showing the states before and after the sliding core 26 is brought into contact with the contact pad 9, both of which are enlarged views of part B of FIG. 5. FIG. 6A shows a state immediately before the sliding core 26 is brought into contact with the contact pad 9. In this state, a flat surface 26a of the sliding core 26 and the first surface 22 (see FIG. 3A), which is a flat surface of the contact pad 9 face each other.

FIG. 6B shows a state in which the flat surface 26a of the sliding core 26 is in contact with the first surface 22. This contact does not involve fitting, and the flat surfaces are in tight contact with each other. Even if the position of the contact pad 9 is offset in the width direction (the direction indicated by arrow a) of the cell 2, the flat surfaces are still in tight contact with each other. That is, according to the configuration of the present embodiment, even if the position of the contact pad 9 is offset in the direction indicated by arrow a within the dimensional tolerance range, it is possible to prevent a gap from being formed in the contact portion between the sliding core 26 and the contact pad 9, and thus resin leakage from the contact portion to the terminal 11 portion can be prevented. Accordingly, molding defects can be prevented, and the cover 14 can be molded stably.

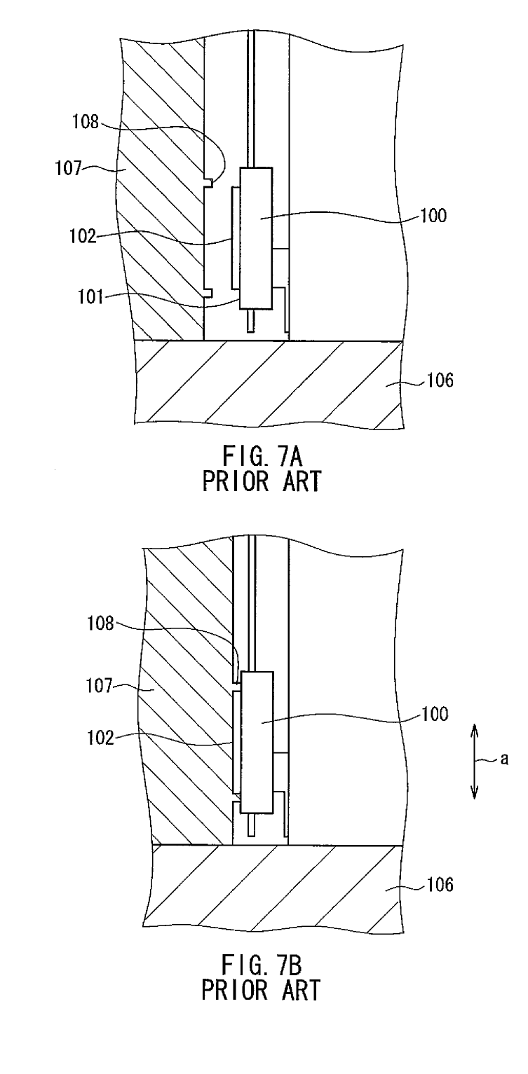

FIGS. 7A and 7B are plan views showing the states before and after a sliding core 107 is brought into contact with the contact pad 100 according to the comparative example. The structure of the contact pad 100 of the comparative example is as shown in FIG. 3B, in which the protruding portion 102 is formed on the first surface 101. The configuration of the comparative example is different from that of the sliding core 26 shown in FIGS. 4A to 6B in that projections 108 are formed on the sliding core 107.

FIG. 7A shows a state immediately before the sliding core 107 is brought into contact with the contact pad 100. In this state, the projections 108 of the sliding core 107 and the first surface 101 (see FIG. 3B), which is a flat surface of the contact pad 100, face each other.

FIG. 7B shows a state in which both ends of the protruding portion 102 of the contact pad 100 are fitted between the projections 108 of the sliding core 107. When a resin is injected in this state, the resin is hindered from flowing into the portion where the terminal 105 is disposed (see FIG. 3B) by the projections 108, and as a result, molding defects can be prevented.

However, if the contact pad 100 is offset in the width direction (the direction indicated by arrow a) of the cell, a situation may occur in which one of the projections 108 of the sliding core 107 is accidentally located on the protruding portion 102 of the contact pad 100. If such a situation occurs, a gap appears between the other projection 108 and the contact pad 100. If such a gap appears, the resin flows into the gap to the portion where the terminal 105 is disposed, resulting in molding defects.

That is, according to the molding method in which the die and the contact pad 100 are brought into contact by fitting the contact pad 100 to the die when molding, a molding defect may occur depending on the degree of offset of the contact pad 100. Therefore, it is hard to say that the aforementioned molding method is always stable. For example, a case may arise where, even if the positional offset of the contact pad 100 is within the tolerance range, the projections 108 and the protruding portion 102 do not fit properly, causing a molding defect.

In contrast, according to the structure of the contact pad 9 of the present embodiment shown in 3A and the molding method of the present embodiment shown in FIGS. 4A to 6B, with the contact pad 9 and the die having simple structures, stable molding is possible regardless of the degree of positional offset of the contact pad 9.

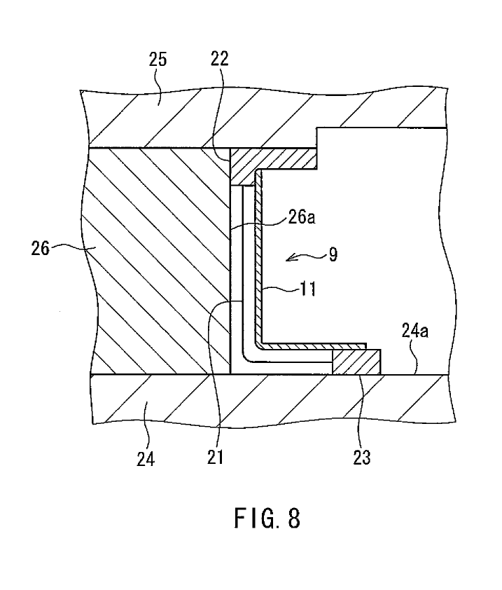

FIG. 8 is an enlarged view of a relevant part showing a contact state between the contact pad and the die, corresponding to an enlarged view of part A of FIG. 4B, and only a relevant part is shown. The flat surface 26a of the sliding core 26 is in contact with the first surface 22 of the contact pad 9. Although not shown in FIG. 8, the flat surface 26a of the sliding core 26 is also in contact with the end surfaces 22a and 22b (see FIG. 3A) of the first surface 22. Accordingly, the flat surface 26a of the sliding core 26 is in contact with the entire first surface 22.

The flat surface 24a of the lower die 24 is in contact with the second surface 23 of the contact pad 9. Although not shown in FIG. 8, the flat surface 24a of the lower die 24 is also in contact with the end surfaces 23a and 23b (see FIG. 3A) of the second surface 23. Accordingly, the flat surface 24a of the lower die 24 is in contact with the entire second surface 23.

As shown in 3A, the surface of the ribs 21 on the first surface 22 side is located at the position recessed from the first surface 22 toward the terminal 11 side, and the surface of the ribs 21 on the second surface 23 side is located at the position recessed from the second surface 23 toward the terminal 11 side. That is, a step is formed between the first surface 22 and the surface of the ribs 21 and between the second surface 23 and the surface of the ribs 21.

With this configuration, as shown in FIG. 8, a gap is always formed between the flat surface 26a of the sliding core 26 and the ribs 21 and between the flat surface 24a of the lower die 24 and the ribs 21. That is, because the die does not come into contact with the ribs 21, the contact of the first surface 22 and the second surface 23 of the contact pad 9 with the die can be more reliably secured. Thus, it is possible to more reliably prevent resin from flowing into the terminal 11 portion of the contact pad 9.

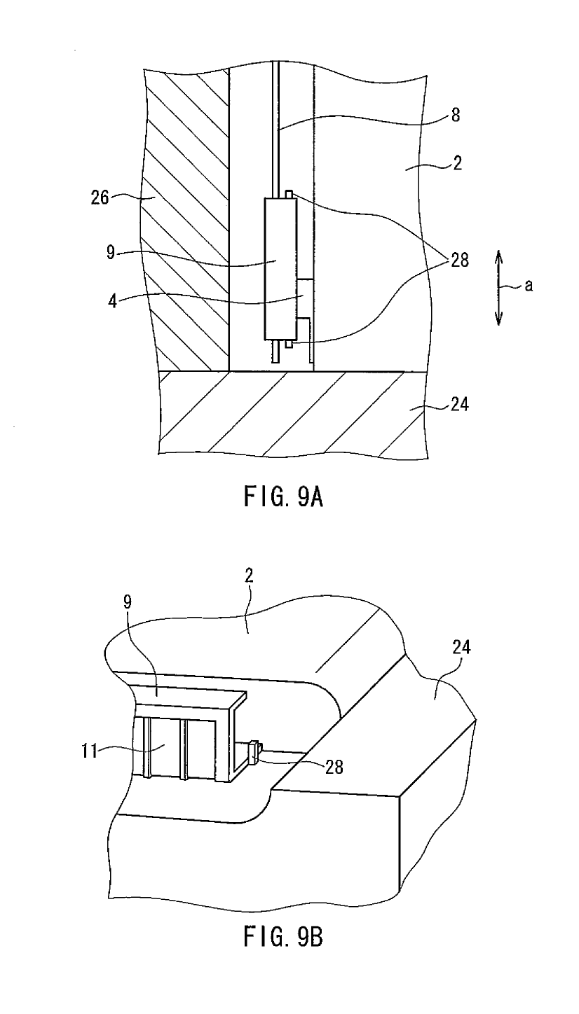

FIGS. 9A and 9B are diagrams illustrating a positioning structure for the contact pad 9. FIG. 9A corresponds to an enlarged view of part B of FIG. 5. FIG. 9B is a perspective view of a relevant part of the positioning structure portion. The lower die 24 shown in FIG. 9 is different from that of the embodiment described above in that projections 28 are formed in the lower die 24. In FIG. 9B, the attached components except for the contact pad 9 are omitted in order to show the projections 28.

When the cell 2 is placed on the lower die 24, both ends of the cell 2 are fitted to both ends of the molding surface of the lower die 24. At this time, both ends of the contact pad 9 are also fitted between the projections 28 fixed to the lower die 24.

The position of the projections 28 is set such that, when both ends of the contact pad 9 are fitted between the projections 28, the position of the contact pad 9 in the width direction (the direction indicated by arrow a) of the cell 2 comes into the proper position. Accordingly, the contact pad 9 is located at the proper position in the width direction of the cell 2 at the time point when the cell 2 is placed on the lower die 24 and both ends of the contact pad 9 are fitted between the projections 28.

Here, the contact pad 9 is fixed to the cell 2 with the protective circuit 8 and the positive electrode tab 4 interposed therebetween. As stated above, the positive electrode tab 4 is fixed to the protective circuit 8 and the positive electrode terminal 3 by welding (see FIG. 1). Accordingly, the position of the contact pad 9 is fixed at the time when welding is finished.

If the fixed position of the contact pad 9 is not within the dimensional tolerance range, the position of the contact pad 9 can be corrected to the proper position by causing both ends of the contact pad 9 to be fitted between the projections 28. Through integral molding in this state, the position of the contact pad 9 is maintained at the proper position even after it is released from the die.

Even though such projections 28 are added, the contact between the surface of the contact pad 9 and the die is the same, that is, a flat surface contact without fitting. Furthermore, because both ends of the contact pad 9 are fitted between the projections 28 in advance when the cell 2 is placed on the lower die 24, rather than fitting the both ends of the contact pad 9 between the projections 28 while closing the die, it is possible to start molding after confirming that the fitting is secure.

The lower die 24 having projections 28 shown in FIGS. 9A and 9B has been described in the context of the lower die being the lower die 24 shown in FIGS. 4A to 6B. However, a configuration is also conceivable in which projections are provided to the lower die 106 of the comparative example shown in FIGS. 7A and 7B. As stated above, with provision of the projections, the position of the contact pad 9 is corrected to the proper position. According to the molding method that involves fitting of the protruding portion 102 of the contact pad 100 between the projections 108 of the sliding core 107 as shown in FIGS. 7A and 7B, as long as the positional accuracy of the contact pad 9 is secured, fitting defects can be suppressed, which helps to reduce molding defects.

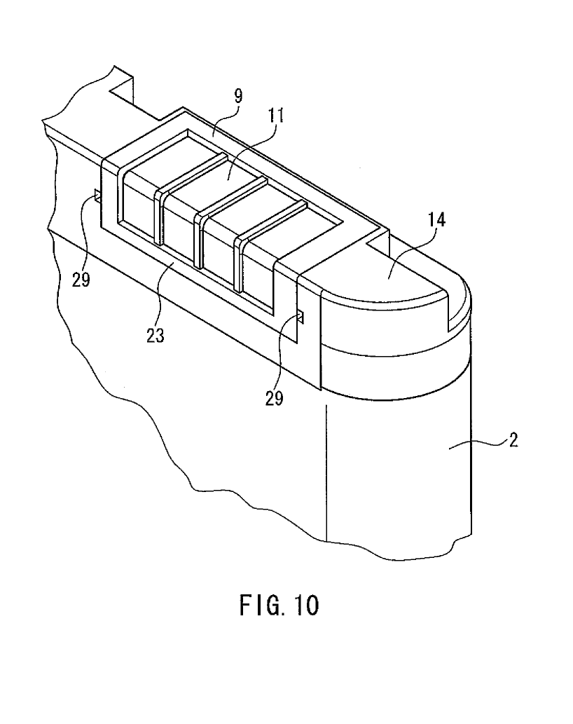

FIG. 10 is a perspective view showing the periphery of the contact pad 9 to which the cover 14 has been molded. Recesses 29 corresponding to the projections 28 of the lower die 24 are formed contacting the end portions of the second surface 23 of the contact pad 9.

The die structures have been explained in the context of the contact pad 9 having the two-surface terminal structure, but the present embodiment is also applicable to a contact pad having a single-surface terminal structure (a structure in which terminal 11 is disposed only on the first surface 22 side as shown in FIG. 3A for example). This is because the contact surface of the die is still flat regardless of the terminal structure being the two-surface terminal structure or single-surface terminal structure.

Also, in the configuration in which projections 28 are provided to the lower die 24 as shown in FIGS. 9A and 9B, the effect of positioning the contact pad 9 to the proper position can be exhibited equally regardless of the terminal structure being the single-surface terminal structure or two-surface terminal structure. That is, according to the present embodiment, stable molding can be achieved while maintaining the simple die structure and the simple structure of the surface of the contact pad regardless of the terminal structure.

Also, an example of attached components of the cell 1 is shown in FIG. 1, but the attached components are not limited to the example shown in FIG. 1 as long as at least a contact pad is included in the attached components.

Also, a recess portion may be formed in the contact surface between the die and the contact pad. This is because the flat surface contact without fitting can be achieved even when a recess portion is formed.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method for manufacturing a battery pack by placing a cell that includes a contact pad attached thereto in a die and molding a cover that is integrated with the cell and the contact pad,
wherein the contact pad comprises a body that includes an opening formed therein, and an external connection terminal disposed at the position of the opening,
the cover is molded by bringing the surface of the body into contact with a die and injecting a resin into a space surrounded by the die and the cell, and
the contact is a flat surface contact without fitting.

2. The method for manufacturing a battery pack according to claim 1, wherein the surface of the body of the contact pad includes a first surface and a second surface that intersects with the first surface, the opening is formed on the first surface side and the second surface side, the terminal is disposed at the position of the opening on the first surface side and the position of the opening on the second surface side, which constitutes a two-surface terminal structure, and in both the first surface and the second surface, the contact is a flat surface contact without fitting.

3. The method for manufacturing a battery pack according to claim 1, wherein the opening of the contact pad is divided by ribs, and the ribs are located at a position recessed from the surface of the body toward the terminal side.

4. A method for manufacturing a battery pack by housing a cell that includes a contact pad attached thereto in a space surrounded by a plurality of dies, and molding a cover that is integrated with the cell and the contact pad,
wherein the contact pad comprises a body that includes an opening formed therein, and an external connection terminal disposed at the position of the opening,
the plurality of dies include a die having projections that fit to both ends of the contact pad,
the cell that includes a contact pad attached thereto is placed on the die having projections, and after both ends of the contact pad are fitted to the projections, the plurality of dies are brought into a closed state, and
a resin is injected into a space surrounded by the plurality of dies and the cell to mold the cover.

5. The method for manufacturing a battery pack according to claim 4, wherein in the closed state of the plurality of dies, the contact between the surface of the body and the plurality of dies is all a flat surface contact without fitting.

6. The method for manufacturing a battery pack according to claim 4, wherein the surface of the body of the contact pad includes a first surface and a second surface that intersects with the first surface, the opening is formed on the first surface side and the second surface side, the terminal is disposed at the position of the opening on the first surface side and the position of the opening on the second surface side, which constitutes a two-surface terminal structure, and the die having projections is a die that corresponds to the first surface or the second surface that serves as a side surface of the cell.

7. A battery pack in which a cover is molded to a cell that includes a contact pad attached thereto so as to integrate with the cell and the contact pad,
wherein the contact pad comprises a body that includes an opening formed therein, and an external connection terminal disposed at the position of the opening, and
the surface of the body has a shape that can make a flat surface contact without fitting together with a die for forming the cover.

8. The battery pack according to claim 7, wherein the surface of the body of the contact pad includes a first surface and a second surface that intersects with the first surface, the opening is formed on the first surface side and the second surface side, the terminal is disposed at the position of the opening on the first surface side and the position of the opening on the second surface side, which constitutes a two-surface terminal structure, and the first surface and the second surface have a shape that can make a flat surface contact without fitting together with a die for forming the cover.

9. The battery pack according to claim 7, wherein the surface of the body is a flat surface or a flat surface in part of which a recess portion is formed.

10. The battery pack according to claim 7, wherein the opening of the contact pad is divided by ribs, and the ribs are located at a position recessed from the surface of the body toward the terminal side.

11. A battery pack in which a cover is molded to a cell that includes a contact pad attached thereto so as to integrate with the cell and the contact pad,
wherein the contact pad comprises a body that includes an opening formed therein, and an external connection terminal disposed at the position of the opening,
a recess is formed in the cover, and
the recess is formed contacting each of both ends of the contact pad.

12. The battery pack according to claim 11,
wherein the surface of the body of the contact pad includes a first surface and a second surface that intersects with the first surface,
the opening is formed on the first surface side and the second surface side,
the terminal is disposed at the position of the opening on the first surface side and the position of the opening on the second surface side, which constitutes a two-surface terminal structure, and
the recesses are formed at both ends of the first surface or the second surface that serves as a side surface of the cell.
